(19) United States
(12) Patent Application Publication
(10) Pub. No.: US 2026/0169128 A1
(43) Pub. Date: Jun. 18, 2026

(54) HYPERSPECTRAL TIME-OF-FLIGHT SENSOR

(71) Applicant: STMicroelectronics International N.V., Geneva (CH)

(72) Inventors: Thomas PEROTTO, Grenoble (FR); Robin VASSAL, Grenoble (FR); Timothee FICHOT, Grenoble (FR)

(21) Appl. No.: 18/985,469

(22) Filed: Dec. 18, 2024

(51) Int. Cl. G01S 7/48; G01S 7/481; G01S 7/484; G01S 7/4863; G01S 7/4865; G01S 17/88

(52) U.S. Cl. CPC G01S 7/4802; G01S 7/4815; G01S 7/484; G01S 7/4863; G01S 7/4866; G01S 17/88

(57) ABSTRACT

An example time-of-flight sensor, a method for determining a physical property of a target using a time-of-flight sensor, and a mobile autonomous electronic system including a time-of-flight sensor are provided. The example time-of-flight sensor, includes a first and a second optical transmitter, a first and a second optical receiver, and a controller. The first and second optical transmitter transmitting a first and second optical signal having a first and second wavelength, respectively. The first optical receiver generating a first feedback signal from reflections of the first optical signal. The second optical receiver generating a second feedback signal from reflections of the second optical signal. The controller generating a first histogram based on the first feedback signal and a second histogram based on the second feedback signal to determine a physical property of a target based on a comparison of the first histogram and the second histogram.

### TECHNOLOGICAL FIELD

Embodiments of the present disclosure relate generally to time-of-flight flight sensors, and more particularly, to time-of-flight sensors configured to determine a physical property of a target.

### BACKGROUND

Time-of-flight sensors have widespread applications across multiple industries due to their ability to measure distances, track objects, detect presence, determine physical properties, and/or map environments with high precision. For example, time-of-flight sensors may be used in consumer electronics for facial recognition, augmented reality, and enhanced focus of a camera. In robotics and autonomous vehicles, time-of-flight sensors may enable obstacle avoidance, improved navigation, and safety through real-time 3D mapping of a surrounding environment. In industrial automation, time-of-flight sensors may be used for precise object detection and monitoring.

Applicant has identified many technical challenges and difficulties associated with utilizing a time-of-flight sensor to determine a physical property of a target. Through applied effort, ingenuity, and innovation, Applicant has solved problems related to determining a physical property of a target using a time-of-flight sensor by developing solutions embodied in the present disclosure, which are described in detail below.

### BRIEF SUMMARY

Various embodiments are directed to an example time-of-flight sensor, a method for determining a physical property of a target using a time-of-flight sensor, and a mobile autonomous electronic system configured to move along a surface aided by a time-of-flight sensor.

An example time-of-flight sensor, comprises a first and a second optical transmitter, a first and a second optical receiver, and a controller. The first optical transmitter configured to transmit a first optical signal having a first wavelength. The second optical transmitter configured to transmit a second optical signal having a second wavelength. The first optical receiver configured to generate a first feedback signal resulting from one or more reflections of the first optical signal. The second optical receiver configured to generate a second feedback signal resulting from one or more reflections of the second optical signal. The controller is configured to generate a first histogram based on the first feedback signal; generate a second histogram based on the second feedback signal; and determine a physical property of a target based on a comparison of the first histogram and the second histogram.

In some embodiments, the time-of-flight sensor further comprises a first filter optic configured to block transmission of the second feedback signal comprising the second wavelength, wherein the first filter optic is positioned between the first optical receiver and the target.

In some embodiments, the time-of-flight sensor further comprises a first reference array configured to receive the first optical signal directly from the first optical transmitter.

In some embodiments, the first histogram is generated based on a comparison of the first feedback signal received at the first optical receiver, and the first optical signal received at the first reference array.

In some embodiments, the time-of-flight sensor further comprises a second filter optic configured to block transmission of the first feedback signal comprising the first wavelength, wherein the second filter optic is positioned between the second optical receiver and the target.

In some embodiments, the time-of-flight sensor further comprises a second reference array configured to receive the second optical signal directly from the second optical transmitter.

In some embodiments, the second histogram is generated based on a comparison of the second feedback signal received at the second optical receiver, and the second optical signal received at the second reference array.

In some embodiments, the target comprises a surface.

In some embodiments, the physical property of the surface is determined based on a classification associated with the first histogram and the second histogram.

In some embodiments, the target comprises an air sample.

In some embodiments, the physical property is a measure of an air quality of the air sample.

In some embodiments, the first optical signal and the second optical signal are transmitted simultaneously.

In some embodiments, the first optical receiver and the second optical receiver integrate over an integration period.

In some embodiments, the integration period alternates between a first integration period and a second integration period.

In some embodiments, the first wavelength and the second wavelength are different.

A method for determining a physical property of a target is further provided. In some embodiments, the method comprises: causing a first optical transmitter to transmit a first optical signal having a first wavelength; causing a second optical transmitter to transmit a second optical signal having a second wavelength; receiving, from a first optical receiver, a first feedback signal resulting from one or more reflections of the first optical signal; receiving, from a second optical receiver, a second feedback signal resulting from one or more reflections of the second optical signal; generating a first histogram based on the first feedback signal; generating a second histogram based on the second feedback signal; and determining the physical property of the target based on a comparison of the first histogram and the second histogram.

In some embodiments, the first histogram further comprises comparing the first feedback signal received at the first optical receiver with the first optical signal received at a first reference array.

In some embodiments, generating the second histogram further comprises comparing the second feedback signal received at the second optical receiver with the second optical signal received at a second reference array.

In some embodiments, the method further comprises causing the first optical signal and the second optical signal to be transmitted simultaneously; and causing the first optical receiver and the second optical receiver to integrate over an integration period, wherein the integration period alternates between a first integration period and a second integration period.

A mobile autonomous electronic system configured to move along a surface is further provided. In some embodiments, the mobile autonomous electronic system comprises a time-of-flight sensor, comprising a first and a second optical transmitter, a first and a second optical receiver, and a controller. The first optical transmitter configured to transmit a first optical signal having a first wavelength. The second optical transmitter configured to transmit a second optical signal having a second wavelength. The first optical receiver configured to generate a first feedback signal resulting from one or more reflections of the first optical signal. The second optical receiver configured to generate a second feedback signal resulting from one or more reflections of the second optical signal. The controller configured to generate a first histogram based on the first feedback signal; generate a second histogram based on the second feedback signal; and determine a physical property of the surface based on a comparison of the first histogram and the second histogram. The mobile autonomous electronic system configured to perform an action based on the physical property of the surface.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example time-of-flight sensor comprising a plurality of optical transmitters and associated optical receivers in accordance with an example embodiment of the present disclosure.

FIG. 2 illustrates an example embodiment of a time-of-flight sensor comprising a first optical transmitter and receiver configured to generate and receive a first optical signal having a first wavelength and a second optical transmitter and receiver configured to generate and receive a second optical signal having a second wavelength in accordance with an example embodiment of the present disclosure.

FIG. 3 illustrates another example embodiment of a time-of-flight configured to operate utilizing two different wavelengths of light in accordance with an example embodiment of the present disclosure.

FIG. 4 illustrates a timing diagram depicting an integration sequence for a plurality of wavelengths of light utilized on a time-of-flight sensor in accordance with an example embodiment of the present disclosure.

FIG. 5 illustrates an example process for determining a physical property of a target utilizing optical signals having two different wavelengths in accordance with an example embodiment of the present disclosure.

FIG. 6 illustrates an example mobile autonomous electronic system comprising a time-of-flight sensor in accordance with an example embodiment of the present disclosure.

FIG. 7 depicts an example block diagram of a controller in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with determining one or more physical properties of a target utilizing time-of-flight data associated with a plurality of optical signals. As understood by those of skill in the field to which the present disclosure pertains, there are numerous electronic systems that may benefit from determining a physical property of a target based on time-of-flight data.

For example, time-of-flight sensors have been utilized in a wide range of varying applications across multiple industries due to their ability to measure distances, track objects, detect presence, determine physical properties, and/or map environments with high precision. For example, time-of-flight sensors are used in consumer electronics for facial recognition, augmented reality, and enhanced focus of a camera. In robotics and autonomous vehicles, time-of-flight sensors are used to enable obstacle avoidance, improved navigation, and safety through real-time 3D mapping of a surrounding environment. In industrial automation, time-of-flight sensors enable precise object detection and monitoring.

In each of these applications, time-of-flight data from the various time-of-flight sensors may be used to classify objects. Object classification may include floor recognition, for example detecting different flooring types (e.g., carpet, tile, hardwood, etc.). Object classification may further include anti-spoofing applications. Anti-spoofing applications may utilize time-of-flight data to determine the authenticity of a particular biometric entry technique. For example, object classification may be utilized to determine if a facial recognition entry was spoofed with a mask or other non-authentic material. Object classification may also include materials detection such as the material makeup of a surface.

In some examples, various algorithms are utilized to identify materials based on optical feedback data. Such algorithms suffer from a number of drawbacks and limitations. For example, some object classification and material identification algorithms utilize image data to perform object classification and/or material identification. Utilizing image data may require expensive materials, such as high resolution image sensors. Utilizing image data may further require complex algorithms on expensive, high performance processors to perform object classification and material identification. Utilizing image data may be further limited in dark or low light conditions.

In addition, some examples utilize object classification and material identification algorithms utilize time-of-flight data to perform object classification and/or material identification. Algorithms utilizing time-of-flight data to perform object classification and/or material identification may also suffer drawbacks. For example, it may not be possible to distinguish materials having similar physical properties with time-of-flight data. Further, in applications in which time-of-flight data is used to determine an air quality, traditional time-of-flight sensors may not be able to distinguish between various particles sizes.

The various example embodiments described herein utilize various techniques to determine a physical property of a target utilizing time-of-flight data from a plurality of optical transmitters and receivers configured to operate with different wavelengths of optical signals. For example, in some embodiments, a time-of-flight sensor comprising a first optical transmitter and a second optical transmitter are provided. The first optical transmitter is configured to generate a first optical signal, directed toward a target in an external environment, and transmitted at a first wavelength. The second optical transmitter is configured to generate a second optical signal, directed toward the target in the external environment, and transmitted at a second wavelength.

The example time-of-flight sensor is further configured with an optical receiver corresponding to each optical transmitter and configured to receive optical signals from the external environment having a corresponding wavelength. For example, a first optical receiver may include filtering optics to allow the first optical receiver to receive reflected signals of the first wavelength. Similarly, a second optical receiver may include filtering optics to allow the second optical receiver to receive reflected signals of the second wavelength.

The time-of-flight sensors described herein further include a controller. In some embodiments, the controller may be configured to generate a histogram for each wavelength of light transmitted by the time-of-flight sensor. Different materials, particles, and/or surfaces (e.g., targets) may exhibit different reflective properties based on the wavelength of the light incident on the target. For example, the various wavelengths of light may be scattered, absorbed, and/or reflected differently by a target based on the wavelength of the light. By transmitting a plurality of wavelengths of light a plurality of histograms may be generated based on each wavelength of light. The plurality of histograms may then be compared to determine a physical property of the target reflecting the transmitted light. For example, in some embodiments, the type of material of the target may be determined (e.g., wood, metal, fabric, etc.). Further, in some embodiments, the shape, contours, and/or texture of the target may be determined (e.g., flat, rough, woven, etc.).

The controller may utilize various mechanisms to determine the type of material and/or texture of the material of the target based on the generated histograms. For example, various characteristics of a histogram may be compiled for different material types and different wavelengths of light. The generated histograms may be compared to the known characteristics and a physical property of the target identified. In some embodiments, machine learning models and/or artificial intelligence techniques may be used to determine a physical property of the target based on the plurality of histograms.

In some embodiments, the time-of-flight sensor in accordance with an example embodiment of the present disclosure may be used on a mobile autonomous electronic system, such as a robotic vacuum. In such an embodiment, an action may be taken based on the classification of the physical property of the target. For example, in an instance in which a shag carpet is detected, the robotic vacuum may avoid the detected surface. Similarly, in an instance in which a flat, hard surface is detected, the side brushes of the robotic vacuum may be slowed or turned off.

In some embodiments, the time-of-flight sensor in accordance with an example embodiment of the present disclosure may be used on to determine air quality of an environment. For example, the time-of-flight sensor may be configured to determine the presence and/or density of certain particles in a target environment. The air quality of the environment may be determined based on the presence and/or density of the particles.

As a result of the herein described example embodiments and in some examples, the performance of object recognition algorithms using time-of-flight sensors may be greatly improved. Such improvements may enable accurate object recognition and material identification using low cost materials. Thus, time-of-flight sensor-based object recognition and material identification techniques may be performed accurately in low cost applications.

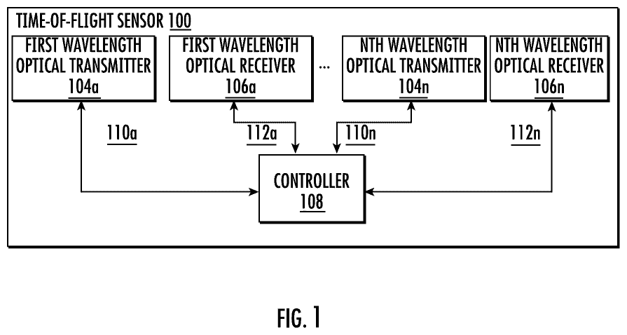

Referring now to FIG. 1, an example time-of-flight sensor 100 is provided. As depicted in FIG. 1, the example time-of-flight sensor 100 includes a first wavelength optical transmitter 104a (e.g., first optical transmitter) and a first wavelength optical receiver 106a (e.g., first optical receiver) electrically connected to a controller 108. The time-of-flight sensor 100 of FIG. 1 further illustrates at least an additional wavelength optical transmitter 104n and an additional wavelength optical receiver 106n, each electrically connected to the controller 108. The controller 108 is configured to transmit control signals 110a, 110n to the plurality of optical transmitters 104a, 104n and receive feedback signals 112a, 112n from the plurality of optical receivers 106a, 106n.

In general, a time-of-flight sensor 100 operates by measuring the time it takes for an optical signal, usually emitted as a laser or infrared pulse from an optical transmitter, to travel to a target object and reflect back to the optical receiver. The time-of-flight sensor 100 calculates the distance to the object based on the speed of light and the time delay between the emission and detection of the optical signal. The time-of-flight of the optical signal may be used to measure a distance to the target object, track the motion of the target object, determine a speed of the target object, detect presence of a target object, determine material properties of a target object, and/or map target objects in an environment with high precision.

As depicted in FIG. 1, the example time-of-flight sensor 100 includes a first wavelength optical transmitter 104a and at least an additional wavelength optical transmitter 104n. An optical transmitter is any device, bulb, semiconductor, light emitting diode, laser, or other photon-emitting structure configured to generate an optical signal. An optical transmitter may comprise any light source, such as a laser diode, a light-emitting diode, bulb, semiconductor device, or other photon-emitting structure. In some embodiments, an optical transmitter may comprise a semiconductor laser diode, for example, a vertical-cavity surface-emitting laser (VCSEL) and/or an edge emitting laser diode. In general, an optical transmitter may output a coherent light beam upon receipt of a current.

An optical transmitter may be configured to generate an optical signal comprising a particular wavelength or range of wavelengths. The wavelength of the transmitted optical signal my be determined based on the structure of the optical transmitter and/or accompanying optical components through which the optical signal passes, for example, a lens, metasurface, or other similar optical device. As depicted in FIG. 1, the time-of-flight sensor 100 is configured to transmit a plurality of optical signals having different optical wavelengths. For example, the first wavelength optical transmitter 104a is configured to transmit an optical signal having a first wavelength; a second wavelength optical transmitter may be configured to transmit an optical signal having a second wavelength; and so on until the nth wavelength optical transmitter 104n is configured to transmit an optical signal having an nth wavelength.

As depicted in FIG. 1, an optical transmitter 104a-104n is any device, bulb, semiconductor, light emitting diode, laser, or other photon-emitting structure configured to generate an optical signal. An optical transmitter 104a-104n may comprise any light source, such as a laser diode, a light-emitting diode, bulb, semiconductor device, or other photon-emitting structure. In some embodiments, an optical transmitter 104a-104n may comprise a semiconductor laser diode, for example, a vertical-cavity surface-emitting laser (VCSEL) and/or an edge emitting laser diode. In general, an optical transmitter 104a-104n may output a coherent light beam upon receipt of a current.

The plurality of optical transmitters 104a-104n are further configured with different optical wavelengths. In some embodiments, the wavelength of the optical transmitters 104a-104n may be configured to provide disparate time-of-flight data based on the application. For example, a second wavelength of a second optical transmitter may be selected to distinguish particular objects of interest when compared to the reflection of a first wavelength optical signal from a first optical transmitter. For example, in a non-limiting embodiment, the first optical transmitter 104a may be configured to generate an optical signal with a wavelength at or near 850 nanometers and the nth optical transmitter 104n may be configured to generate an optical signal with a wavelength at or near 940 nanometers.

As further depicted in FIG. 1, the optical transmitters 104a-104n are configured to receive a control signal 110a-110n. A control signal 110a-110n is any electromagnetic signal generated by a controller 108 to configure the operation of the optical transmitters 104a-104n. For example, the control signal 110a-110n may configure the intensity, pulse parameters (e.g., pulse width, pulse duration, pulse frequency), timing, and/or other parameters related to the transmitted optical signal. In some embodiments, the control signal 110a-110n may be configured to coordinate the plurality of optical transmitters 104a-104n to transmit simultaneously.

As further depicted in FIG. 1, the example time-of-flight sensor 100 includes a first wavelength optical receiver 106a and at least an additional wavelength optical receiver 106n. An optical receiver is any set of one or more photodiodes, integrated circuits, devices, sensors, light sensing diodes, or other photodetector structures that produce an electric signal (e.g., feedback signal 112a-112n) as a result of light received at the optical receiver. For example, the electric signal output by the optical receiver may increase as the number of photons that strike the optical receiver per second increases. In such an embodiment, the electric current output from the optical receiver may be used to determine the intensity or amplitude of the optical radiation striking the optical receiver. In some embodiments, the optical receiver may be a light sensitive semiconductor diode that creates an electron-hole pair at the p-n junction when a photon of sufficient energy strikes the optical receiver. In some embodiments, the optical receiver may comprise one or more single-photon avalanche diodes (SPADs) configured to generate an avalanche current when one or more photons strike the optical receiver.

An optical receiver may further comprise a plurality of photodetector structures (e.g., pixels) arranged in a two-dimensional array. In such an embodiment, each pixel corresponds to a real-world location in the external environment. The electrical output (e.g., feedback signal 112a-112n) from each pixel may correspond to the amount of light received from the corresponding real-world location. In an instance in which the pixel is integrated over a period of time, the electrical output from each pixel may represent the amplitude of light received from the particular real-world location, and the controller 108 may use the feedback signal 112a-112n to generate one or more histograms. In an instance in which the feedback signal 112a-112n is accumulated for a specific time period relative to the generation of the transmitted optical signal, the controller 108 may generate a depth histogram for each pixel location.

Determinations about target objects may be made based on the returning optical signal reflected off one or more target objects, for example, the distance of the target object, the motion of the target object, the speed of the target object, surface properties of the target object, and so on.

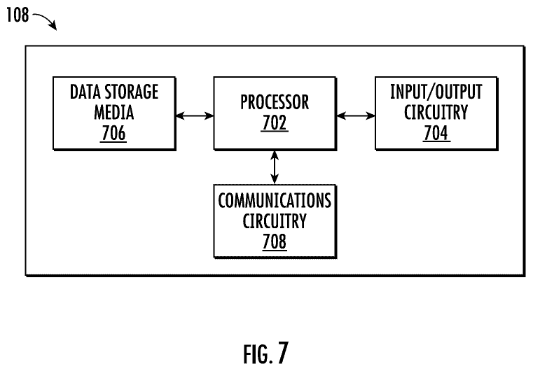

As further depicted in FIG. 1, the example time-of-flight sensor 100 includes a controller 108. A controller 108 comprises any circuitry including hardware and/or software configured to coordinate the operation of the various components of the time-of-flight sensor 100, including the plurality of optical transmitters 104a-104n, the plurality of optical receivers 106a-106n, and the plurality of reference arrays. Example components of a controller 108 are further described in relation to FIG. 7. In some embodiments, the controller 108 may be external to the time-of-flight sensor 100. For example, the controller 108 may be included on a host system, for example, as a host processor.

A controller 108 is further configured to generate a histogram for each wavelength of transmitted optical signal based on the feedback signals 112a-112n received from each of the plurality of optical receivers 106a-106n. During operation, an optical transmitter (e.g., optical transmitter 104a-104n) may transmit an optical pulse into an external environment. An optical receiver (e.g., optical receiver 106a-106n) may collect data related to the returning optical signal reflected off a target in the external environment and received at the optical receiver 106a-106n based on the elapsed time since the optical pulse was transmitted. The controller 108 may collect the data based on the feedback signal 112a-112n in a depth histogram for each wavelength of light. The depth histogram may comprise a plurality of bins, wherein each bin corresponds to a different time window since the optical signal was transmitted.

For example, a first bin of the depth histogram may correspond to the light received at the optical receiver 106a-106n during the first bin time period after the optical pulse was transmitted; a second bin of the depth histogram may correspond to the light received at the optical receiver 106a-106n during the second bin time period after the optical pulse was transmitted; the third bin of the depth histogram may correspond to the light received at the optical receiver 106a-106n during the third bin time period after the optical pulse was transmitted; and so on.

Optical pulses are periodically transmitted and the returning optical signal accumulated in bins over an integration period. For example, an integration period may include hundreds or thousands of pulses and last for tens of milliseconds. During the integration period, counts in each of the bins of the histogram are accumulated. The counts accumulated in the bin represent the amount of light received at the optical receiver 106a-106n during the time period corresponding to the bin. Thus, at the end of an integration period, data values in the histogram (e.g., peaks) exceeding the noise level may indicate one or more times at which reflections of the optical signal were received corresponding to a target in the external environment. Such data values in the histogram may be used to determine physical characteristics of the target objects in an external environment.

In addition, the histogram may change based on the wavelength of the transmitted and received optical signals. For example, for a single target, some wavelengths of light may be directly reflected, causing a sharp peak in the histogram for that wavelength. However, for other wavelengths of light, the light may be scattered, or absorbed. In such an instance, the response captured in the histogram may be spread over a wider range of bins. By transmitting, receiving, and generating histograms for two different wavelengths of light, certain physical characteristics of a target may be determined.

A controller 108 is further configured to determine a physical property of a target based on a comparison of one or more histograms generated based on different wavelengths of the transmitted optical signal. A controller 108 may perform any operation to determine features of a histogram. For example, a controller 108 may determine one or more statistical properties of a histogram, such as maximum bin value, minimum bin value, number of bins exceeding a threshold noise value, relative position of bins exceeding the threshold noise level, standard deviation of bin values, average bin value, and other similar statistics. A controller 108 may further determine histogram difference statistics. For example, the controller 108 may compare one or more features of a first histogram associated with a first wavelength of light with one or more features of a second histogram associated with a second wavelength of light. In some embodiments, a controller 108 may perform a distribution analysis on each of the histograms and compare the distribution analysis. For example, the controller 108 may determine the kurtosis or skewness of each distribution for comparison. The difference may indicate certain physical properties of the target, such as material type of the target may be determined (e.g., wood, metal, fabric, etc.), shape, contours, and/or texture of the target may also be determined (e.g., flat, rough, woven, etc.). In addition, one or more distributions may be compared to a referential distribution. Comparison with one or more referential distributions may further indicate the physical properties of the target.

For example, in some embodiments, particular physical properties of a target may be associated with differences in a first histogram associated with a first wavelength of light and a second histogram associated with a second wavelength of light. In some embodiments, physical properties of a target may be associated with characteristics of the plurality of histograms during a training phase. For example, differences in a first histogram associated with a first wavelength of light and a second histogram associated with a second wavelength of light may be connected to a particular material type of a target. A controller 108 may utilize any mechanism to associate the difference in histograms, or any other histogram characteristics, with a particular physical characteristic of a target. Various features of the plurality of histograms may be altered to distinguish physical characteristics of various targets. For example, the number of wavelengths of light for which histograms may be generated, and thus the number of histograms, may be increased or decreased. Similarly, the various wavelengths of light transmitted by the plurality of optical transmitters 104a-104n may be adjusted. In addition, various metrics related to the histograms and the comparison of histograms may be determined. Each variable may be adjusted to further distinguish various material types, shapes, contours, sizes, and/or textures in a particular application.

In some embodiments, a machine learning model may be utilized by a controller 108 to determine a physical characteristic of a target. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. A machine learning model may access various data features to provide predicted outcomes, for example, statistics and metrics related to the various histograms, comparisons of the plurality of histograms, number of wavelengths of light for which histograms are generated, number of histograms, wavelengths of transmitted light, and so on. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised learning or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). A training dataset may be derived from historical data associated with various target types. For example, the features of generated histograms may be correlated with the type and texture of a particular target.

In some embodiments, the machine learning model can be trained in real-time (e.g., online training) while in use. For example, a machine learning model may be trained based on reinforcement learning. A reinforcement learning may receive rewards or penalties based on actions taken or predictions. Reinforcement learning is based on rewarding desired behaviors and punishing undesired ones. A reinforcement learning model is configured over time to perform actions that lead to maximum reward. A reinforcement learning model includes an agent configured to take actions, receive rewards based on the actions, and update the machine learning model to maximize the received reward. In one non-limiting example, feedback from a mobile autonomous electronic system may be used as a reward in a reinforcement learning model. For example, errors asserted by the mobile autonomous electronic system in response to navigating over a particular target surface may indicate a penalty associated with the particular target surface and thus determined histogram features.

The machine learning models described above may make use of multiple ML engines, e.g., for analysis, recommendation generating, transformation, and other needs.

The machine learning models may be any suitable model for the task or activity implemented by each machine learning-based engine. Machine learning models are known in the art and are typically some form of neural network. The term refers to the ability of systems to recognize patterns on the basis of existing algorithms and data sets to provide solution concepts. The more they are trained, the greater knowledge they develop.

The underlying machine learning models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

Alternatively, machine learning models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or autoencoders) to generate definitions and elements.

In various embodiments, the machine learning models may undergo a training or learning phase before they are released into a production, runtime, or classification phase or may begin operation with models from existing systems or models. During a training or learning phase, the machine learning models may be tuned to focus on specific variables, to reduce error margins, or to otherwise optimize their performance. The machine learning models may initially receive input from a wide variety of data, such as the gathered data described herein.

A classifier algorithm estimates a classification model from a set of training data. The classifier algorithm uses one or more classifiers and an associated algorithm to determine a probability or likelihood that a set of data belongs to another set of data. A decision tree model where a target variable can take a discrete set of values is called a classification tree (e.g., and therefore can be considered a classifier or classification algorithm).

A supervised model or predictive model is an estimate of a mathematical relationship in which the value of a dependent variable is calculated from the values of one or more independent variables. The functional form of the relationship is determined by the specific type (e.g., decision tree, Generalized Linear Model, gradient boosted trees) of supervised model. Individual numeric components of the mathematical relationship are estimated based on a set of training data. The set of functional forms and numerical estimates a specific type of supervised model can represent is called its “hypothesis space”.

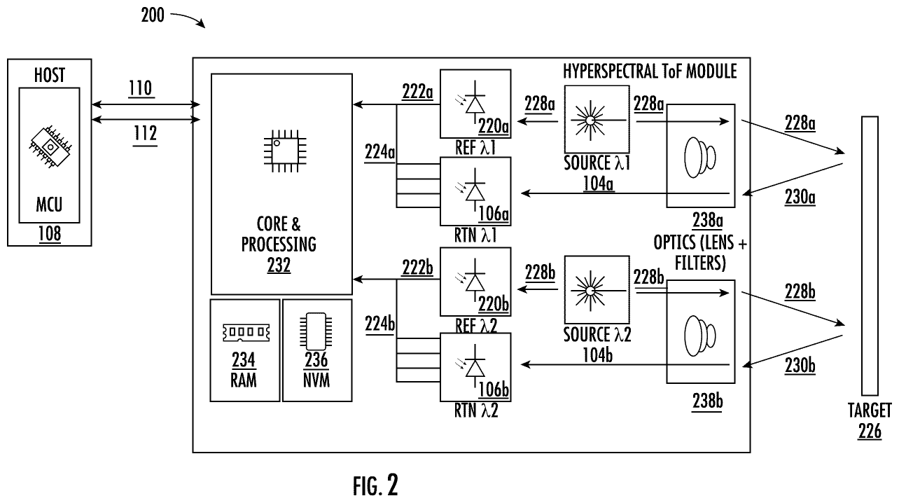

Referring now to FIG. 2, an example hyperspectral time-of-flight sensor 200 operating with two optical signals 228a, 228b having different optical wavelengths, is provided. As depicted in FIG. 2, the example time-of-flight sensor 200 includes a first optical transmitter 104a configured to generate a first optical signal 228a having a first wavelength. A portion of the first optical signal 228a is transmitted directly to the first reference array 220a. In addition, a portion of the first optical signal 228a is transmitted through a first optical structure 238a into an external environment, and toward a target 226. A portion of the first optical signal 228a is reflected by the target 226 and returns to the time-of-flight sensor 200 as first reflected optical signal 230a. The first reflected optical signal 230a passes through the first optical structure 238a and is received by the first optical receiver 106a.

As further depicted in FIG. 2, the example time-of-flight sensor 200 includes a second optical transmitter 104b configured to generate a second optical signal 228b having a second wavelength. A portion of the second optical signal 228b is transmitted directly to the second reference array 220b. In addition, a portion of the second optical signal 228b is transmitted through a second optical structure 238b into an external environment, and toward a target 226. A portion of the second optical signal 228b is reflected by the target 226 and returns to the time-of-flight sensor 200 as second reflected optical signal 230b. The second reflected optical signal 230b passes through the second optical structure 238b and is received by the second optical receiver 106b.

In some embodiments, the first optical structure 238a includes a first filter optic. A first filter optic comprises any optical structure configured to filter light by wavelength. For example, the first optical structure 238a may include a first filter optic configured to enable the passage of light having the first wavelength, and prevent passage of other wavelengths of light, for example, the second optical signal 228b. Thus, the first optical receiver 106a receives reflected signals associated with the first optical transmitter 104a.

In some embodiments, the second optical structure 238b includes a second filter optic. A second filter optic comprises any optical structure configured to filter light by wavelength. For example, the second optical structure 238b may include a second filter optic configured to enable the passage of light having the second wavelength, and prevent passage of other wavelengths of light, for example, the first optical signal 228a. Thus, the second optical receiver 106b receives reflected signals associated with the second optical transmitter 104b.

As further depicted in FIG. 2, the first reference array 220a is configured to generate a first reference signal 222a. The first reference array 220a is positioned to receive a portion of the optical signal 228a at the time of transmission. The first reference array 220a may be configured to generate a first reference signal 222a as a baseline in analyzing the first return signal 224a and determining physical properties of the target 226. In some embodiments, a reference histogram may be generated based on the first reflected optical signal 230a. The reference histogram may be compared with the received histogram based on the first return signal 224a to determine various features of the first reflected optical signal 230a and of the target 226.

In general, two arrays (e.g., reference array and optical receiver) are needed to determine a time of flight. When an optical signal is emitted, the optical signal will first bounce inside the internal module cavity and hit the reference array. Then, the light will continue to travel to the target 226, reflect off the target 226, and come back to hit the return array (e.g., optical receiver). By subtracting the time difference between return and reference arrays the time of flight may be precisely measured.

As further depicted in FIG. 2, the second reference array 220b is configured to generate a second reference signal 222b. The second reference array 220b is positioned to receive a portion of the optical signal 228b at the time of transmission. The second reference array 220b may be configured to generate a second reference signal 222b as a baseline in analyzing the second return signal 224b and determining physical properties of the target 226. In some embodiments, a reference histogram may be generated based on the second reflected optical signal 230b. The reference histogram may be compared with the received histogram based on the second return signal 224b to determine various features of the second reflected optical signal 230b and of the target 226.

As further depicted in FIG. 2, the example time-of-flight sensor 200 includes an onboard processor 232, random-access memory 234, and non-volatile memory 236. The onboard processor 232, random-access memory 234, and non-volatile memory 236 enable the interface with the time-of-flight sensor 200. For example, the onboard processor 232 may be configured communicate with external devices, such as a controller 108 through a communication protocol, such as the inter-integrated circuit (I2C) protocol, the I3C protocol, and/or the mobile industry processor interface (MIPI) protocol. In some embodiments, the onboard processor 232, random-access memory 234, and non-volatile memory 236 may also store instructions, configurations, and settings to operate the various components of the time-of-flight sensor 200 according to one or more control signals 110 provided by an external controller 108. Further, the onboard processor 232 may be configured to generate the histograms for each of the channels (e.g., optical signal 228a, 228b).

As further depicted in FIG. 2, the time-of-flight sensor 200 may be configured to interface with a host controller 108. The host controller 108 provides various configuration settings to the time-of-flight sensor 200 through one or more control signals 110. For example, the host controller 108 may utilize control signals to synchronize the transmission of the first optical signal 228a and the second optical signal 228b. The host controller 108 may further provide intensity, pulse parameters (e.g., pulse width, pulse duration, pulse frequency), timing, and/or other parameters related to the transmitted optical signals (e.g., first optical signal 228a, second optical signal 228b).

In addition to configuring the time-of-flight sensor 200 for operation, the controller 108 may receive the feedback signals 112 corresponding to each of the wavelength channels, wherein a channel includes an optical transmitter, a reference array, and an optical receiver all configured to operate at a particular frequency. The controller 108 utilizes the feedback signals 112 to build a histogram for each wavelength associated with each channel. Thus, the controller 108 generates a histogram for each wavelength of light.

As further described in relation to FIG. 1, the time-of-flight sensor 200 determines features based on the histograms for each wavelength channel. Features may include statistical properties related to each of the histograms of the wavelength channel, for example, maximum bin value, minimum bin value, number of bins exceeding a threshold noise value, relative position of bins exceeding the threshold noise level, standard deviation of bin values, average bin value, and other similar statistics. The features may also include comparison statistics between histograms of wavelength channels, for example, differences and/or ratios in maximum bin value, minimum bin value, number of bins exceeding a threshold noise value, relative position of bins exceeding the threshold noise level, standard deviation of bin values, average bin value, and other similar statistics.

As further described in FIG. 1, the controller 108 may utilize any technique to determine a classification of a target 226. For example, statistical comparisons to targets 226 with know physical properties, machine learning models, or other similar techniques. Although depicted as separate from the time-of-flight sensor 200 in FIG. 2, some or all of the functionality of the controller 108 may be performed on the time-of-flight sensor 200.

As further depicted in FIG. 2, the first optical signal 228a and the second optical signal 228b are directed at a target 226. A target 226 comprises any object, structure, surface, or plurality of objects or structures, for which a time-of-flight sensor 200 is configured to determine a physical property. In one example embodiment, the target 226 comprises any object within the field-of-view of the time-of-flight sensor 200. For example, the time-of-flight sensor 200 may comprise a mobile autonomous electronic system configured to move through an environment autonomously. The mobile autonomous electronic system may utilize a time-of-flight sensor 200 to identify and/or classify objects and/or surfaces based on the histograms from a plurality of wavelengths of light. In such an embodiment, a physical property may include an object type (e.g., wall, chair, toy, etc.), a target material (e.g., wood, metal, fabric, etc.), a texture of the target (e.g., flat, rough, woven, etc.), or other similar physical property of the target 226.

In another example embodiment, the target 226 comprises a quantity of air. A hyperspectral time-of-flight sensor 200 may utilize the histograms of a plurality of wavelengths of light to determine one or more physical properties of the quantity of air, such as an air quality. For example, the time-of-flight sensor 200 may be utilized to determine the size, number, and/or concentration of certain particles indicative of air pollution. For example, a time-of-flight sensor 200 in accordance with the present disclosure may be configured to determine the concentration of particulate matter (PM) particles smaller than 2.5 micrometers in a quantity of air. Such a concentration may be an indicator of hazardous levels of pollution in the air, or poor air quality.

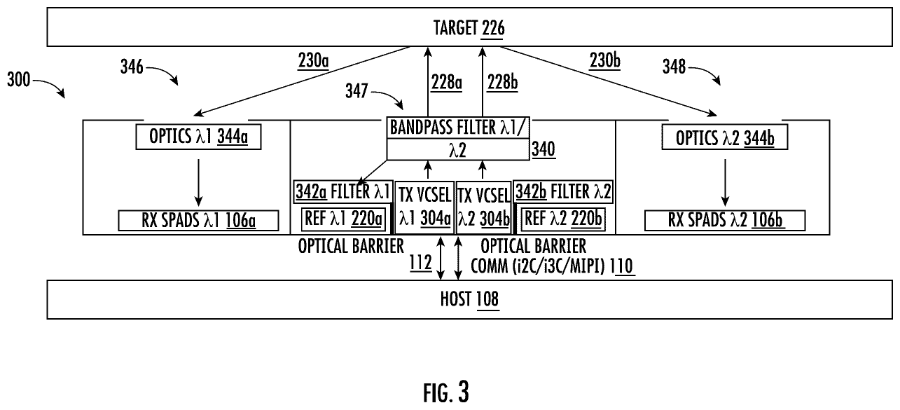

Referring now to FIG. 3, an example cross section of a hyperspectral time-of-flight sensor 300 is provided. As depicted in FIG. 3, the time-of-flight sensor includes a first transmit VCSEL 304a (e.g., first optical transmitter) configured to generate a first optical signal 228a having a first wavelength. A portion of the first optical signal 228a is transmitted directly to the first reference array 220a. In addition, a portion of the first optical signal 228a is transmitted through a bandpass filter 340, configured to allow the transmission of optical signals having the first wavelength. The first optical signal 228a is transmitted through the bandpass filter 340 into an external environment, and toward a target 226.

A portion of the first optical signal 228a is reflected by the target 226 and returns to the time-of-flight sensor 300 as first reflected optical signal 230a. The first reflected optical signal 230a passes through the first filter optic 344a and is received by the first optical receiver 106a.

As further depicted in FIG. 2, the example time-of-flight sensor 200 includes a second transmit VCSEL 304b (e.g., second optical transmitter) configured to generate a second optical signal 228b having a second wavelength. A portion of the second optical signal 228b is transmitted directly to the second reference array 220b. In addition, a portion of the second optical signal 228b is transmitted through a bandpass filter 340, configured to allow the transmission of optical signals having the second wavelength. The second optical signal 228b is transmitted through the bandpass filter 340 into an external environment, and toward a target 226.

A portion of the second optical signal 228b is reflected by the target 226 and returns to the time-of-flight sensor 300 as second reflected optical signal 230b. The second reflected optical signal 230b passes through a second filter optic 344b and is received by the second optical receiver 106b.

As further depicted in FIG. 3, the time-of-flight sensor 300 is configured to interface with a host controller 108. The host controller 108 provides various configuration settings and/or operation commands to the time-of-flight sensor 300 through one or more control signals 110. In addition to configuring the time-of-flight sensor 300 for operation, the controller 108 may receive the feedback signals 112 corresponding to each of the wavelength channels. The controller 108 utilizes the feedback signals 112 to build a histogram for each wavelength associated with each channel. Thus, the controller 108 generates a histogram for each wavelength of light.

As further described in relation to FIG. 1 and FIG. 2, the time-of-flight sensor 300 determines one or more physical properties of the target 226 based on the features of each of the histograms and/or based on comparisons of the histograms. The controller 108 may utilize any technique to determine a classification of a target 226 based on the histograms. For example, statistical comparisons to targets 226 with know physical properties, machine learning models, or other similar techniques.

As further depicted in FIG. 3, the time-of-flight sensor 300 includes three apertures 346, 347, 348. An aperture 346, 347, 348 is any hold, gap, or opening through which an optical signal may pass. As depicted in FIG. 3, the aperture 347 is configured to enable the optical signals (e.g., optical signals 228a, 228b) to exit the time-of-flight sensor 300 toward the target 226. The bandpass filter 340 is positioned in the aperture 347 to enable the passage of the first optical signal 228a comprising a first wavelength (λ1) as determined by the first transmit VCSEL 304a, and the second optical signal 228b comprising a second wavelength (λ2) as determined by the second transmit VCSEL 304a.

As further depicted in FIG. 3, the time-of-flight sensor 300 includes an aperture 346 configured to enable the transmission of the first reflected optical signal 230a comprising light having a first wavelength (λ1). As depicted in FIG. 3, the first filter optic 344a is positioned within the aperture 346 between the external environment and the first optical receiver 106a. The first filter optic 344a comprises any optical structure configured to filter light by wavelength. For example, the first filter optic 344a may be configured to enable the passage of light having the first wavelength (λ1), and prevent passage of other wavelengths of light, for example, the second optical signal 228b (λ2). Thus, the first optical receiver 106a receives reflected signals associated with the first transmit VCSEL 304a.

As further depicted in FIG. 3, the time-of-flight sensor 300 includes an aperture 348 configured to enable the transmission of the second reflected optical signal 230b comprising light having a second wavelength (λ2). As depicted in FIG. 3, the second filter optic 344b is positioned within the aperture 348 between the external environment and the second optical receiver 106b. The second filter optic 344b comprises any optical structure configured to filter light by wavelength. For example, the second filter optic 344b may be configured to enable the passage of light having the second wavelength (λ2), and prevent passage of other wavelengths of light, for example, the first optical signal 228a (λ1). Thus, the second optical receiver 106b receives reflected signals associated with the second transmit VCSEL 304b.

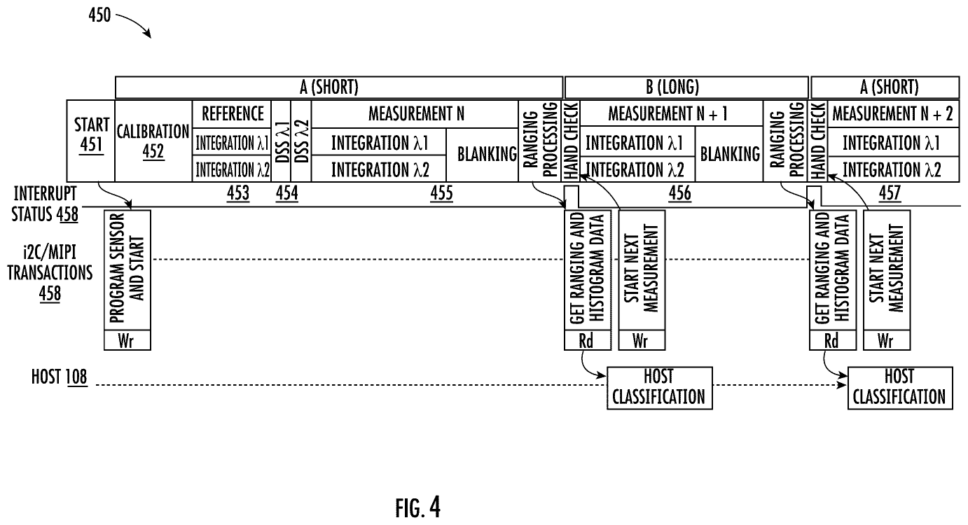

Referring now to FIG. 4, an example timing diagram 450 is provided. As depicted in FIG. 4, a hyperspectral time-of-flight sensor (e.g., time-of-flight sensor 100, 200, 300) may be configured to generate and process the histograms for each of the wavelengths of light in parallel. For example, as shown in the timing diagram 450, the process for classifying a physical property of a target begins at the start period 451.

Various calibration operations are performed in the calibration period 452. For example, temperature calibration is performed and voltage calibrations for single-photon avalanche diodes (SPADs) are performed.

At the reference calibration period 453, the optical transmitters (e.g., first transmit VCSEL 304a, second transmit VCSEL 304b) are illuminated and the reference arrays (e.g., first reference array 220a, second reference array 220b) are utilized to determine various properties of the optical transmitter, for example, the time required for the VCSEL to become fully illuminated.

At the dynamic SPAD selection period 454, the SPAD arrays of the reference arrays (e.g., reference arrays 220a, 220b) and the optical receivers (e.g., optical receivers 106a, 106b) are calibrated, for example, a dynamic SPAD selection operation at each of the arrays is performed.

Once calibration is performed, the first measurement (e.g., Measurement N) is performed. As depicted in FIG. 4, the measurement is performed in parallel for both the first wavelength (λ1) and the second wavelength (λ2) during a short integration period 455. At the conclusion of the short integration period 455, the time-of-flight sensor processor executes processing operations. An interrupt is asserted (e.g., interrupt status 458) and the ranging and histogram data is transmitted to the host controller 108 to perform classification algorithms to determine a physical property of the target object (e.g., target 226).

In the meantime, the second measurement (e.g., Measurement N+1) is started. As depicted in FIG. 4, the second measurement is a long integration period. The time-of-flight sensor may alternate between a short integration period (e.g., short integration period 455) and a long integration period (long integration period 456) to counteract inaccuracies due to wrap around, in which a target object is outside of the range of the integration period and the reflected optical signal arrives during the next integration period. Removing inaccuracies from the generated histograms enables more accurate determination of the physical properties of the target. In addition, a long integration period 456 may provide different benefits from a short integration period 455. For example, the long integration period 456 may provide more accurate time-of-flight measurements by improving the signal to noise ratio. At the conclusion of the long integration period 456, the time-of-flight sensor processor executes processing operations, an interrupt is asserted (e.g., interrupt status 458), and the ranging and histogram data is transmitted to the host controller 108 to perform classification algorithms to determine a physical property of the target object (e.g., target 226).

As further depicted in the timing diagram 450 of FIG. 4, the third measurement (e.g., Measurement N+2) is once again a short integration period 457.

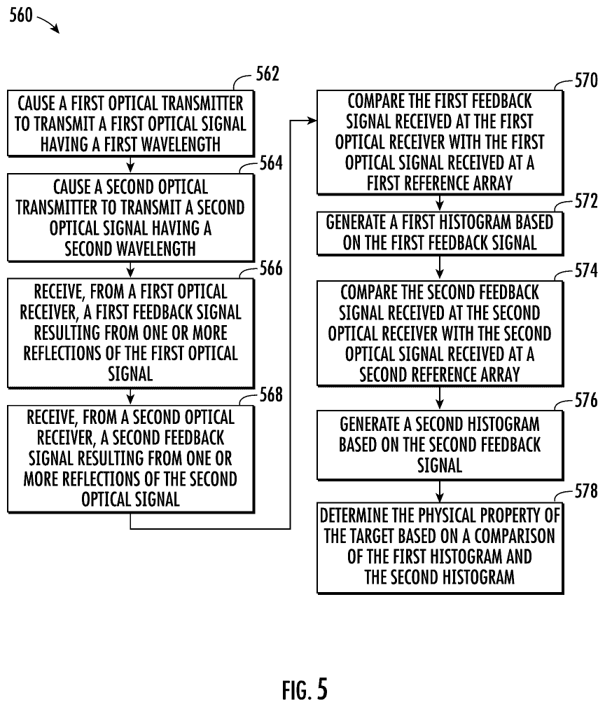

Referring now to FIG. 5, an example process 560 for determining a physical property of a target (e.g., target 226) utilizing optical signals (e.g., optical signals 228a, 228b) having a plurality of wavelengths (e.g., λ1, λ2) is provided. At block 562, a controller (e.g., controller 108) causes a first optical transmitter (e.g., first optical transmitter 104a, first transmit VCSEL 304a) to transmit a first optical signal (e.g., first optical signal 228a) having a first wavelength (e.g., λ1). In some embodiments, the controller may configure a time-of-flight sensor (e.g., time-of-flight sensor 100, 200, 300) to generate the first optical signal through one or more control signals. In some embodiments, the controller may configure to the time-of-flight sensor to periodically transmit optical signals automatically. The wavelength of the transmitted optical signal may be dependent on the configuration of the first optical transmitter.

At block 564, the controller causes a second optical transmitter (e.g., second optical transmitter 104b, second transmit VCSEL 304b) to transmit a second optical signal (e.g., second optical signal 228b) having a second wavelength (e.g., λ2). In some embodiments, the controller may configure the time-of-flight sensor to generate the second optical signal through one or more control signals. In some embodiments, the controller may configure to the time-of-flight sensor to periodically transmit optical signals automatically. The wavelength of the transmitted optical signal may be dependent on the configuration of the second optical transmitter. In some embodiments, the controller may cause the first optical transmitter and the second optical transmitter to transmit simultaneously, such that integration and processing of the first optical signal and the second optical signal may be done in parallel.

At block 566, the controller receives, from a first optical receiver (e.g., first optical receiver 106a), a first feedback signal (e.g., first feedback signal 112a) resulting from one or more reflections of the first optical signal. As described herein, a portion of the first optical signal may be reflected by the target object back toward the time-of-flight sensor. A first filter optic is positioned between the first optical receiver and the target to enable the passage of light comprising the first wavelength. The first feedback signal is generated based on the amount of light received at the first optical receiver during an integration period. The first feedback signal is transmitted to the controller for further processing.

At block 568, the controller receives, from a second optical receiver (e.g., second optical receiver 106b), a second feedback signal (e.g., second feedback signal 112b) resulting from one or more reflections of the second optical signal. As described herein, a portion of the second optical signal may be reflected by the target object back toward the time-of-flight sensor. A second filter optic is positioned between the second optical receiver and the target to enable the passage of light comprising the second wavelength. The second feedback signal is generated based on the amount of light received at the second optical receiver during an integration period. The second feedback signal is transmitted to the controller for further processing.

At block 570, the controller compares the first feedback signal received at the first optical receiver with the first optical signal received at a first reference array (e.g., first reference array 220a). By comparing the first feedback signal reflected off the target, with the first optical signal received directly at the first reference array, the controller may distinguish the portions of the first feedback signal that are attributable with light reflected off the target with received light from unwanted sources.

At block 572, the controller generates a first histogram based on the first feedback signal. The first optical signal may comprise optical pulses periodically transmitted. The first feedback signal generated based on photons received at the first optical receiver may be accumulated in bins over an integration period. For example, an integration period may include hundreds or thousands of pulses and last for tens of milliseconds. During the integration period, counts in each of the bins of the histogram are accumulated based on when the reflected optical signal is received. The counts accumulated in the bin represent the amount of light received at the optical receiver during the time period corresponding to the bin. Thus, at the end of an integration period, data values in the histogram (e.g., peaks) exceeding the noise level may indicate one or more times at which reflections of the optical signal were received corresponding to a target in the external environment. Such data values in the histogram may be used to determine physical characteristics of the target objects in an external environment.

At block 574, the controller compares the second feedback signal received at the second optical receiver with the second optical signal received at a second reference array (e.g., second reference array 220b). By comparing the second feedback signal reflected off the target, with the second optical signal received directly at the second reference array, the controller may distinguish the portions of the second feedback signal that are attributable to light reflected off the target with received light from unwanted sources.

At block 576, the controller generates a second histogram based on the second feedback signal. The second optical signal may comprise optical pulses periodically transmitted. The second feedback signal generated based on photons received at the second optical receiver may be accumulated in bins over an integration period. For example, an integration period may include hundreds or thousands of pulses and last for tens of milliseconds. During the integration period, counts in each of the bins of the histogram are accumulated based on when the reflected optical signal is received. The counts accumulated in the bin represent the amount of light received at the optical receiver during the time period corresponding to the bin. Thus, at the end of an integration period, data values in the histogram (e.g., peaks) exceeding the noise level may indicate one or more times at which reflections of the optical signal were received corresponding to a target in the external environment. Such data values in the histogram may be used to determine physical characteristics of the target objects in an external environment.

At block 578, the controller determines the physical property of the target based on a comparison of the first histogram and the second histogram. As described herein, the controller may utilize any technique to determine a classification of a target based on the first histogram and the second histogram. For example, statistical comparisons to targets with know physical properties, machine learning models, or other similar techniques.

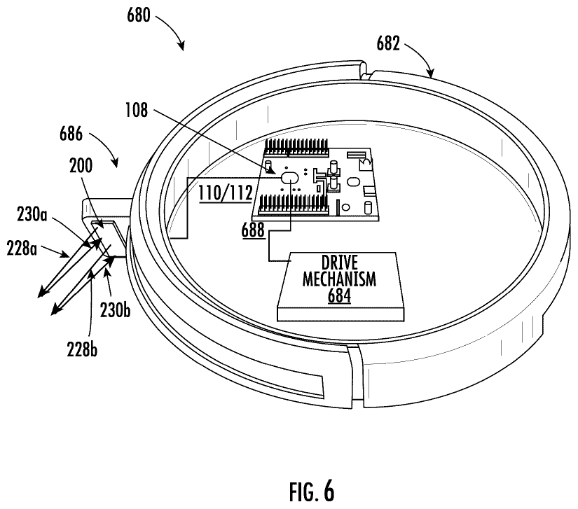

Referring now to FIG. 6, a perspective view of an example mobile autonomous electronic system (e.g., robotic vacuum 680) is provided. As depicted in FIG. 6, the robotic vacuum 680 comprises a housing 682 defining the outer dimensions of the robotic vacuum 680 and providing protection to the internal components. A host controller 108 is disposed within the housing 682 of the robotic vacuum 680.

As further depicted in FIG. 6, the host controller 108 of the robotic vacuum 680 is electrically connected to a drive mechanism 684. The drive mechanism 684 is any electrical and/or mechanical structures configured to move and/or rotate a mobile autonomous electronic system, such as a robotic vacuum 680. In some embodiments, the robotic vacuum 680 may include two or more wheels connected to a motor. The drive mechanism 684 may drive the robotic vacuum 680 by causing the rotation of one or more wheels connected to the motor in sequence.

The drive mechanism 684 may drive the robotic vacuum 680 according to a direction and a speed based on one or more drive commands 688 provided by the controller 108 through a communication interface via a communication protocol. The direction may be expressed as a body relative direction, for example, forward, backward, left, or right, where the direction of transmission of a time-of-flight sensor 200 is forward.

The drive mechanism 684 may further perform one or more rotations based on one or more drive commands 688 received from the host controller 108. For example, the drive mechanism 684 may perform a rotation by causing the rotation of one or more wheels connected to the motor. For example, operating two separate wheels at different rotational speeds may cause the robotic vacuum 680 to rotate.

As further depicted in FIG. 6, the controller 108 is electrically connected to a time-of-flight sensor 200 in accordance with the present disclosure. As depicted in FIG. 6, the time-of-flight sensor 200 is positioned such that the first optical signal 228a and the second optical signal 228b are directed in a forward direction relative to the robotic vacuum 680. As further illustrated in FIG. 6, the first optical signal 228a (e.g., having a first wavelength) and the second optical signal 228b (e.g., having a second wavelength) are directed toward the surface 686 the robotic vacuum 680 is driving on. The first reflected optical signal 230a and the second reflected optical signal 230b return to the time-of-flight sensor 200 after interacting with the surface 686 and are received by the time-of-flight sensor 200. By pointing the optical signals toward the surface 686 the robotic vacuum 680 is driving on, the controller 108 may determine certain physical properties of the surface 686. For example, the controller 108 may determine the type and/or material of the surface 686 (e.g., hardwood, carpet, tile, metal, clothing, blanket, etc.). In some embodiments, the optical signals may be pointed in a forward direction and configured to identify the type and material of various objects in front of the robotic vacuum 680.

The robotic vacuum 680 may perform various actions based on the physical properties of the target surface 686. For example, the controller 108 may cause the robotic vacuum to avoid a particular target surface 686 by transmitting one or more signals to the drive mechanism 684 causing the robotic vacuum 680 to reverse and/or drive around the detected target surface 686. For example, the robotic vacuum 680 may be configured to recognize a sheet of paper on the floor and may navigate a path to avoid the sheet of paper. In another example, the robotic vacuum 680 may reconfigure the robotic vacuum 680 settings based on the physical properties of the surface 686. For example, the robotic vacuum 680 may adjust the suction power, enable or disable counter rotating brushes, enable or disable the side brushes, increase or decrease speed of side/underneath brushes, enable or disable mopping features, and so on.

By utilizing a plurality of optical signals (e.g., first optical signal 228a, second optical signal 228b) each transmitted at a different wavelength, and analyzing the histograms associated with the reflected optical signals (e.g., first reflected optical signal 230a, second reflected optical signal 230b) the controller 108 may determine certain physical properties about the target objects (e.g., surface 686) and perform various actions based on the type of surface. Utilizing time-of-flight sensors 200 and a plurality of wavelengths of light enable the robotic vacuum 680 to accurately determine physical properties of a target at a low cost by removing the need for expensive imaging sensors and high power processing resources.

Referring now to FIG. 7, FIG. 7 illustrates an example controller 108 in accordance with at least some example embodiments of the present disclosure. The controller 108 includes processor 702, input/output circuitry 704, data storage media 706, and communications circuitry 708. In some embodiments, the controller 108 is configured, using one or more of the sets of circuitry 702, 704, 706, and/or 708, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the controller 108 provide or supplement the functionality of other particular sets of circuitry. For example, the processor 702 in some embodiments provides processing functionality to any of the sets of circuitry, the data storage media 706 provides storage functionality to any of the sets of circuitry, the communications circuitry 708 provides network interface functionality to any of the sets of circuitry, and/or the like.

In some embodiments, the processor 702 (and/or co-processor or any other processing circuitry assisting or otherwise associated with the processor) is/are in communication with the data storage media 706 via a bus for passing information among components of the controller 108. In some embodiments, for example, the data storage media 706 is non-transitory and may include, for example, one or more volatile and/or non-volatile memories. In other words, for example, the data storage media 706 in some embodiments includes or embodies an electronic storage device (e.g., a computer readable storage medium). In some embodiments, the data storage media 706 is configured to store information, data, content, applications, instructions, or the like, for enabling the controller 108 to carry out various functions in accordance with example embodiments of the present disclosure.

The processor 702 may be embodied in a number of different ways. For example, in some example embodiments, the processor 702 includes one or more processing devices configured to perform independently. Additionally, or alternatively, in some embodiments, the processor 702 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 108, and/or one or more remote or “cloud” processor(s) external to the controller 108.

In an example embodiment, the processor 702 is configured to execute instructions stored in the data storage media 706 or otherwise accessible to the processor. Alternatively, or additionally, the processor 702 in some embodiments is configured to execute hard-coded functionality. As such, whether configured by hardware or software methods, or by a combination thereof, the processor 702 represents an entity (e.g., physically embodied in circuitry) capable of performing operations according to an embodiment of the present disclosure while configured accordingly. Alternatively, or additionally, as another example in some example embodiments, when the processor 702 is embodied as an executor of software instructions, the instructions specifically configure the processor 702 to perform the algorithms embodied in the specific operations described herein when such instructions are executed.

In some embodiments, the controller 108 includes input/output circuitry 704 that provides output to the user and, in some embodiments, to receive an indication of a user input. In some embodiments, the input/output circuitry 704 is in communication with the processor 702 to provide such functionality. The input/output circuitry 704 may comprise one or more user interface(s) (e.g., user interface) and in some embodiments includes a display that comprises the interface(s) rendered as a web user interface, an application user interface, a user device, a backend system, or the like. The processor 702 and/or input/output circuitry 704 comprising the processor may be configured to control one or more functions of one or more user interface elements through computer program instructions (e.g., software and/or firmware) stored on a memory accessible to the processor (e.g., data storage media 706, and/or the like). In some embodiments, the input/output circuitry 704 includes or utilizes a user-facing application to provide input/output functionality to a client device and/or other display associated with a user.

In some embodiments, the controller 108 includes communications circuitry 708. The communications circuitry 708 includes any means such as a device or circuitry embodied in either hardware or a combination of hardware and software that is configured to receive and/or transmit data from/to a network and/or any other device, circuitry, or module in communication with the controller 108. In this regard, the communications circuitry 708 includes, for example in some embodiments, a network interface for enabling communications with a wired or wireless communications network. Additionally, or alternatively in some embodiments, the communications circuitry 708 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 708 includes circuitry for interacting with the antenna(s) and/or other hardware or software to cause transmission of signals via the antenna(s) or to handle receipt of signals received via the antenna(s). In some embodiments, the communications circuitry 708 enables transmission to and/or receipt of data from a client device in communication with the controller 108.

Additionally, or alternatively, in some embodiments, one or more of the sets of circuitry 702-914 are combinable. Additionally, or alternatively, in some embodiments, one or more of the sets of circuitry perform some or all of the functionality described associated with another component. For example, in some embodiments, one or more sets of circuitry 702-708 are combined into a single module embodied in hardware, software, firmware, and/or a combination thereof. Similarly, in some embodiments, one or more of the sets of circuitry is/are combined such that the processor 702 performs one or more of the operations described above with respect to each of these circuitry individually.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that may utilize time-of-flight sensors for object detection and/or material detection. For example, any robotic device, such as a robotic mop, robotic vacuum, robotic lawn mower, robotic delivery bot, robotic virtual assistant, etc.; an air pollution monitor, or other particle detector; biometric security devices, such as facial recognition systems and fingerprint detection; and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A time-of-flight sensor, comprising:
a first optical transmitter configured to transmit a first optical signal having a first wavelength;
a second optical transmitter configured to transmit a second optical signal having a second wavelength;
a first optical receiver configured to generate a first feedback signal resulting from one or more reflections of the first optical signal;
a second optical receiver configured to generate a second feedback signal resulting from one or more reflections of the second optical signal; and
a controller configured to:
generate a first histogram based on the first feedback signal;
generate a second histogram based on the second feedback signal; and
determine a physical property of a target based on a comparison of the first histogram and the second histogram.

2. The time-of-flight sensor of claim 1, further comprising a first filter optic configured to block transmission of the second feedback signal comprising the second wavelength, wherein the first filter optic is positioned between the first optical receiver and the target.

3. The time-of-flight sensor of claim 2, further comprising:
a first reference array configured to receive the first optical signal directly from the first optical transmitter.

4. The time-of-flight sensor of claim 3, wherein the first histogram is generated based on a comparison of the first feedback signal received at the first optical receiver, and the first optical signal received at the first reference array.

5. The time-of-flight sensor of claim 1, further comprising a second filter optic configured to block transmission of the first feedback signal comprising the first wavelength, wherein the second filter optic is positioned between the second optical receiver and the target.

6. The time-of-flight sensor of claim 5, further comprising:
a second reference array configured to receive the second optical signal directly from the second optical transmitter.

7. The time-of-flight sensor of claim 6, wherein the second histogram is generated based on a comparison of the second feedback signal received at the second optical receiver, and the second optical signal received at the second reference array.

8. The time-of-flight sensor of claim 1, wherein the target comprises a surface.

9. The time-of-flight sensor of claim 8, wherein the physical property of the surface is determined based on a classification associated with the first histogram and the second histogram.

10. The time-of-flight sensor of claim 1, wherein the target comprises an air sample.

11. The time-of-flight sensor of claim 10, wherein the physical property is a measure of an air quality of the air sample.

12. The time-of-flight sensor of claim 1, wherein the first optical signal and the second optical signal are transmitted simultaneously.

13. The time-of-flight sensor of claim 12, wherein the first optical receiver and the second optical receiver integrate over an integration period.

14. The time-of-flight sensor of claim 13, wherein the integration period alternates between a first integration period and a second integration period.

15. The time-of-flight sensor of claim 1, wherein the first wavelength and the second wavelength are different.

16. A method for determining a physical property of a target, the method comprising:
causing a first optical transmitter to transmit a first optical signal having a first wavelength;
causing a second optical transmitter to transmit a second optical signal having a second wavelength;
receiving, from a first optical receiver, a first feedback signal resulting from one or more reflections of the first optical signal;
receiving, from a second optical receiver, a second feedback signal resulting from one or more reflections of the second optical signal;
generating a first histogram based on the first feedback signal;
generating a second histogram based on the second feedback signal; and
determining the physical property of the target based on a comparison of the first histogram and the second histogram.

17. The method of claim 16, wherein generating the first histogram further comprises:
comparing the first feedback signal received at the first optical receiver with the first optical signal received at a first reference array.

18. The method of claim 16, wherein generating the second histogram further comprises:
comparing the second feedback signal received at the second optical receiver with the second optical signal received at a second reference array.

19. The method of claim 16, further comprising:
causing the first optical signal and the second optical signal to be transmitted simultaneously; and
causing the first optical receiver and the second optical receiver to integrate over an integration period,
wherein the integration period alternates between a first integration period and a second integration period.

20. A mobile autonomous electronic system configured to move along a surface, the mobile autonomous electronic system comprising:
a time-of-flight sensor, comprising:
a first optical transmitter configured to transmit a first optical signal having a first wavelength;
a second optical transmitter configured to transmit a second optical signal having a second wavelength;
a first optical receiver configured to generate a first feedback signal resulting from one or more reflections of the first optical signal;
a second optical receiver configured to generate a second feedback signal resulting from one or more reflections of the second optical signal; and
a controller configured to:
generate a first histogram based on the first feedback signal;
generate a second histogram based on the second feedback signal; and
determine a physical property of the surface based on a comparison of the first histogram and the second histogram;
wherein the mobile autonomous electronic system is configured to perform an action based on the physical property of the surface.
